(19) United States
(12) Patent Application Publication
(10) Pub. No.: US 2008/0226887 A1
(43) Pub. Date: Sep. 18, 2008

(54) Low resistivity light attenuation anti-reflection coating with a transparent surface conductive layer

(76) Inventor: Cheng-Chieh Chang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/717,028

(22) Filed: Mar. 13, 2007

(51) Int. Cl. B32B 9/04

(52) U.S. Cl. 428/220; 428/411.1; 428/446

(57) ABSTRACT

A low resistivity light attenuation anti-reflection coating with a transparent surface conductive layer is disclosed. The multi-layered structure of the low resistivity light attenuation anti-reflection coating is HL (HL)₆HL (H: a material scoring high on the refractive index, L: a material scoring low on the refractive index). There are 8 oxide layers, and the material of the surface layer is a transparent conductive coating and scores between 1.9 and 2.0 on the refractive index.

### BACKGROUND OF THE INVENTION

1. Field of the Invention

The present invention relates to a low resistivity light attenuation anti-reflection coating with a transparent surface conductive layer. In particular, this invention relates to a multi-layer system that has a high anti-reflection effect.

2. Description of the Related Art

An anti-reflection multi-layer system is usually used for a plastic substrate, a glass substrate, or a plastic web. A great number of multi-layer systems have previously been disclosed.

U.S. Pat. No. 4,921,760 discloses a multi-layer anti-reflection coating with excellent adhesion between the CeO₂ layer and the synthetic resin. The layer system includes CeO₂, Al₂O₃, ZrO₂, SiO₂, TiO₂, and Ta₂O₅. All the thin films of the layer system are oxide materials. There are 3 to 5 thin layers in the layer system. For example, the total thickness of the 5-layer structure is about 3580 angstroms. The material of the surface layer of the layer system is SiO₂, which scores low on the refractive index at about 1.46 at 550 nm.

U.S. Pat. No. 5,105,310 discloses a multi-layer anti-reflection coating designed for in-line coating matched with reactive sputtering. The layer system includes TiO₂, SiO₂, ZnO, ZrO₂, and Ta₂O₅. All the thin films of the layer system are oxide materials. There are 4 to 6 thin layers in the layer system. For example, the total thickness of the 6-layer structure is about 4700 angstroms. The material of the surface layer of the layer system is SiO₂, which scores low on the refractive index at about 1.46 at 550 nm.

U.S. Pat. No. 5,091,244 and 5,407,733 disclose a new type of electric conductive light-attenuating anti-reflection coating. The major claim is an article comprising of nitrides of a certain transition metal that provides an electrically conductive, light-attenuating, anti-reflection surface. The layer system includes TiN, NbN, SnO₂, SiO₂, Al₂O₃, and Nb₂O₅. The thin films of the layer system are nitride and oxide materials. There are 3 to 4 thin layers in the layer system. For example, the total thickness of the 4-layer structure is about 1610 angstroms. The transmission of visible light through these two-layer systems is less than 50%. The material of the surface layer of the layer system is SiO₂, which scores low on the refractive index at about 1.46 at 550nm.

U.S. Pat. No. 5,147,125 discloses a multi-layer, anti-reflection coating using zinc oxide that provides shielding from UV wavelengths shorter than 380 nm. The layer system includes TiO₂, SiO₂, ZnO, and MgF₂. All the thin films of the layer system are oxide and fluorine. There are 4 to 6 thin layers in the layer system. For example, the total thickness of the 5-layer structure is about 7350 angstroms. The material of the surface layer of the layer system is MgF₂, which scores low on the refractive index at about 1.38 at 550 nm.

U.S. Pat. No. 5,170,291 discloses a 4-layer system, which is optical effective and has a high anti-reflective effect. The layers can be formed by a pyrolytic method, a plasma-supported chemical vapor deposition method, a sputtering method, or a chemical deposition method. The layer system includes SiO₂, TiO₂, Al₂O₃, ZnS, MgO, and Bi₂O₃. For example, the total thickness of the 4-layer structure is about 2480 angstroms. The material of the surface layer of the layer system is SiO₂, which scores low on the refractive index at about 1.46 at 550 nm.

U.S. Pat. No. 5,216,542 discloses a 5-layer coating with a high anti-reflection effect. The process uses an adhesive layer of Ni, Cr, or NiCr metal with a thickness of about 1 nm (manometer). The other four layers are composed of SnO₂, ZrO₂, ZnO, Ta₂O₅, NiO, CrO₂, TiO₂, Sb₂O₃, In₂O₃, Al₂O₃, SiO₂, TiN, and ZrN. For example, the total thickness of the 5-layer structure is about 2337 angstroms. The transmission of visible light through this layer system is less than 30%. The material of the surface layer of the layer system is SiO₂, which scores low on the refractive index at about 1.46 at 550 nm.

U.S. Pat. No. 5,541,770 discloses a light attenuating anti-reflection coating including electrically conductive layers. It is a four or five-layer system. A light absorption high refractive index metal such as Cr, Mo, or W is used as an optically effective thin film in the layer system. The other three or four layers are TiO₂, ITO, Al₂O₃, SiO₂, or TiN. The patent discloses that the majority materials of the layer system are oxide and nitride, and only one metal film is used as an optical effective thin film in the anti-reflection coating. For example, the total thickness of the 5-layer structure is about 1495 angstroms. The transmission of visible light through this layer system is less than 60%. The material of the surface layer of the layer system is SiO₂, which scores low on the refractive index at about 1.46 at 550 nm.

U.S. Pat. No. 5,362,552 discloses a 6-layer anti-reflection coating including three layers of an electrically conductive metal oxide. The layer system includes SiO₂, ITO, Nb₂O₅, and Ta₂O₅. A total optical thickness of up to about one-wavelength of visible light of the electrically conductive metal oxide may be included in the coating. As an example of the 6-layer structure, the materials and thickness of the major two layers within this 6-layer system are SiO₂ (854 angstroms), and ITO (1975 angstroms). Moreover, the material of the surface layer of the layer system is SiO₂, which scores low on the refractive index at about 1.46 at 550 nm.

U.S. Pat. No. 5,579,162 discloses a 4-layer anti-reflection coating for a temperature sensitive substrate such as plastic. One layer is a DC reactively sputtered metal oxide that may be deposited quickly and without imparting a large amount of heat to the substrate. The layer system includes SnO₂, SiO₂, and ITO. For an example of the 4-layered structure, the materials and thickness of the major two layers within this system are SnO₂ (763 angstroms), and SiO₂ (940 angstroms). The material of the surface layer of the layer system is SiO₂, which scores low on the refractive index at about 1.46 at 550 nm.

U.S. Pat. Nos. 5,728,456 and 5,783,049 disclose an improved way to deposit anti-reflection coating on plastic film. The multi-layer thin film is coated via a roller coating with a sputtering process. The layer system includes ITO, SiO₂, and a thin lubricating covering layer that is a solvent-soluble fluoropolymer. For example, the total thickness of the 6-layer system is about 2630 angstrom. The material of the surface layer of the layer system is SiO₂, which scores low on the refractive index at about 1.46 at 550 nm.

The above descriptions show clearly that the material of the thin surface layer of the conventional optical layer system is SiO₂ or MgF₂, which score low on the refractive index at about 1.46 and 1.38 at 550 nm, respectively.

It is well known that the conventional layer structure for an anti-reflection optical coating has a general principle. This general principle is that the surface layer of the optical coating should be a material that scores low on the refractive index such as SiO₂, scoring 1.46 on the refractive index, or MgF₂, scoring 1.38 on the refractive index. However, when we apply the anti-reflection coating on a display screen to create an anti-static effect for a computer monitor, or low reflection glass for an LCD or a PDP, there are some bottlenecks in the process of high volume mass production. The basic reason is in the conventional optical layer structure the conductive layer is buried by an insulating layer, for example SiO₂ or MgF₂.

In the general design rule for an anti-reflection coating, the first layer deposited on the substrate surface is a material with a high score on the refractive index (hereafter referred to as H), which is then followed by a second layer which is a material with a low score on the refractive index (hereafter referred to as L). The basic design rule for the conventional anti-reflection coating has a layer structure such as HLHL or HL HL HL. In a simple case, if the materials of H are ITO and the materials of L are SiO₂, the 4-layered structure is glass/ITO/SiO₂/ITO/SiO₂. Because ITO is a transparent conductive material, the multi-layer coating of this layer structure has electrical conductivity of less than 100Ω/square, and can be used as an EMI shielding and/or electric static discharge when the conductive coating layer is bonded to ground. However, a troubling phenomenon is that if the surface material of the conventional optical layer structure is SiO₂, the typical thickness of the SiO₂ layer is about 1000 Å. The material characteristic of SiO₂ is that it has a high density, inert property in chemical and is a very good insulating layer for electricity. In the process of applying a conventional anti-reflection coating to a display screen, it is difficult to make an electrical contact with the buried ITO layer that is isolated by the outermost SiO₂ layer. For a typical grounding process to make a metal contact with the ITO layer, an ultra-sonic welding procedure is needed to break the insulating layer (SiO₂) and to make sure a good contact of tin solder is made with the buried ITO conductive layer. This process slows down the application of anti-reflection coating in high volume production.

Alternatively, the ultra-sonic welding process produces small and bright contamination because of the liquid tin, and the explosive energy of the ultrasonic process. This process also produces inconsistent contact resistance for each bus bar line because the ultrasonic-welding process cannot consistently break the insulating coating at the same depth evenly and obtain a uniform contact resistance with the ITO layer.

The drawbacks mention above will reduce the yield and reliability of the manufacturing process for the application of conventional anti-EMI and anti-reflection coating.

### SUMMARY OF THE INVENTION

One particular aspect of the present invention is to provide a low resistivity light attenuation anti-reflection coating with a transparent surface conductive layer. The anti-reflection layer system is composed of 8 oxide layers, and the material of the surface layer is a transparent conductive layer that scores high (between 1.9 to 2.2) on the refractive index.

Another particular aspect of the present invention is to provide a low resistivity light attenuation anti-reflection coating with a transparent surface conductive layer. The process of manufacturing oxide thin film in high volume production is highly reliable and has been routinely used in industries such as semiconductor manufacturing, disc head manufacturing, LCD manufacturing, CRT manufacturing, architecture glass manufacturing, touch sensor display manufacturing, screen filter manufacturing and plastic web coating for more than twenty years.

A further particular aspect of the present invention is to provide a low resistivity light attenuation anti-reflection coating with a transparent surface conductive layer. The layer structure is HL(HL)6H. The low resistivity light attenuation anti-reflection coating is composed of 8 layers of oxide materials, and the material of the surface layer is a transparent conductive layer that scores high (between 1.9 to 2.2) on the refractive index. In one embodiment, the material of the surface layer is a kind of transparent conductive coating, such as SnO₂, ZnO₂, In₂O₃, or ITO.

A further particular aspect of the present invention is to provide a low resistivity light attenuation anti-reflection coating with a transparent surface conductive layer. The material of the surface layer of the low resistivity light attenuation anti-reflection coating is a transparent conductive layer. The photopic reflectance of the transparent surface conductive layer is below 0.5%. The resistivity of the transparent surface conductive layer is as low as 0.5Ω/square to 0.7Ω/square, and its transpancy is between 55% and 70%.

Because the surface layer has good electrical conductive properties, the layer system reduces much of the work in the grounding process and also increases the total yield and reliability in high volume production. The present invention provides a surface conductive layer structure of anti-reflection coating that can be applied to the LCD and PDP display industries for glass and plastic film substrates.

In one embodiment of the present invention of the anti-reflection coating, there are 15 layers, namely, the first, second, third . . . and fifteen layers in consecutive numerical order beginning with the layer furthest from the substrate. Each layer is described in terms of physical or optical thickness. The optical thickness is a mathematical product of a layer's thickness and its score on the refractive index. It is described as a fraction of a designed wavelength. In the present invention the designed wavelength is about 520 nm.

The first layer or the surface layer is a transparent conductive oxide material. The oxide layer is preferably ZnO:Al slightly absorption for visible light, which scores between 1.9 and 2.2 on the refractive index at a wavelength of about 520 nanometers (nm) and has a physical thickness of 20 nm to 40 nm at the designed wavelength.

The second layer is a thin metal material. The metal layer is preferably silver, slightly absorption for visible light, scores between 0.1 and 0.5 on the refractive index, at a wavelength of about 520 nm, and has a physical thickness of 8 to 12 nm at the designed wavelength.

The third layer is an oxide material. The oxide layer is preferably ZnO:Al, slightly absorption for visible light, scores between 1.9 and 2.2 on the refractive index at a wavelength of about 520 nanometers (nm) and has a physical thickness of 30 nm to 80 nm at the designed wavelength.

The fourth layer is a thin metal material. The metal layer is preferably silver slightly absorption for visible light, scores between 0.1 and 0.5 on the refractive index at a wavelength of about 520 nm and has a physical thickness between 8 and 12 nm.

The fifth layer is an oxide material. The oxide layer is preferably ZnO:Al slightly absorption for visible light, scores between 1.9 and 2.2 on the refractive index at a wavelength of about 520 nanometers (nm) and has a physical thickness between 30 nm and 80 nm at the designed wavelength.

The sixth layer is a thin metal material. The metal layer is preferably silver slightly absorption for visible light, scores between 0.1 and 0.5 on the refractive index at a wavelength of about 520 nm and has a physical thickness between 8 and 12 nm.

The seventh layer is an oxide material. The oxide layer is preferably ZnO:Al slightly absorption for visible light, scores 1.9 to 2.2 on the refractive index at a wavelength of about 520 nanometers (nm) and has a physical thickness of 30 nm to 80 nm at the designed wavelength.

The eighth layer is a thin metal material. The metal layer is preferably silver slightly absorption for visible light, scores between 0.1 and 0.5 on the refractive index at a wavelength of about 520 nm and has a physical thickness of 8 to 12 nm.

The ninth layer is an oxide material. The oxide layer is preferably ZnO:Al slightly absorption for visible light, scores between 1.9 and 2.2 on the refractive index at a wavelength of about 520 nanometers (nm) and has a physical thickness between 30 nm and 80 nm at the designed wavelength.

The tenth layer is a thin metal material. The metal layer is preferably silver slightly absorption for visible light, scores between 0.1 and 0.5 on the refractive index at a wavelength of about 520 nm and has a physical thickness of 8 to 12 nm.

The eleventh layer is an oxide material. The oxide layer is preferably ZnO:Al slightly absorption for visible light, scores between 1.9 to 2.2 on the refractive index at a wavelength of about 520 nanometers (nm) and has a physical thickness between 30 nm and 80 nm at the designed wavelength.

The twelfth layer is a thin metal material. The metal layer is preferably silver slightly absorption for visible light, scores between 0.1 and 0.5 on the refractive index at a wavelength of about 520 nm and has a physical thickness of 8 to 12 nm.

The thirteenth layer is an oxide material, the oxide layer is preferably ZnO:Al slightly absorption for visible light, scores between 1.9 and 2.2 on the refractive index at a wavelength of about 520 nanometers (nm) and has a physical thickness of 30 nm to 80 nm at the designed wavelength.

The fourteenth layer is a thin metal material. The metal layer is preferably silver slightly absorption for visible light, scores between 0.1 and 0.5 on the refractive index at a wavelength of about 520 nm and has a physical thickness of 8 to 12 nm.

The fifteenth or the innermost layer is an oxide material. The oxide layer is preferably TiO2 substantially non-absorption for visible light, scores between 2.2 and 2.4 on the refractive index at a wavelength of about 520 nm and has a physical thickness of 20 to 40 nm at the designed wavelength.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the low resistivity light attenuation anti-reflection coating with a transparent surface conductive layer of the present invention; and

FIG. 2 is a curve diagram of the relationship between the reflection rate and the wavelength of the low resistivity light attenuation anti-reflection coating with a transparent surface conductive layer of the present invention.

### DETAILED DESCRIPTION OF THE PREFERRED EMBODIMENTS

The present invention relates to an oxide based anti-reflection coating with 15 layers. The thickness value of each layer is specified as either a physical thickness in nm, as an optical thickness in the form of a fraction, or as a multiple of a wavelength of visible light. The typical value is 520 nm.

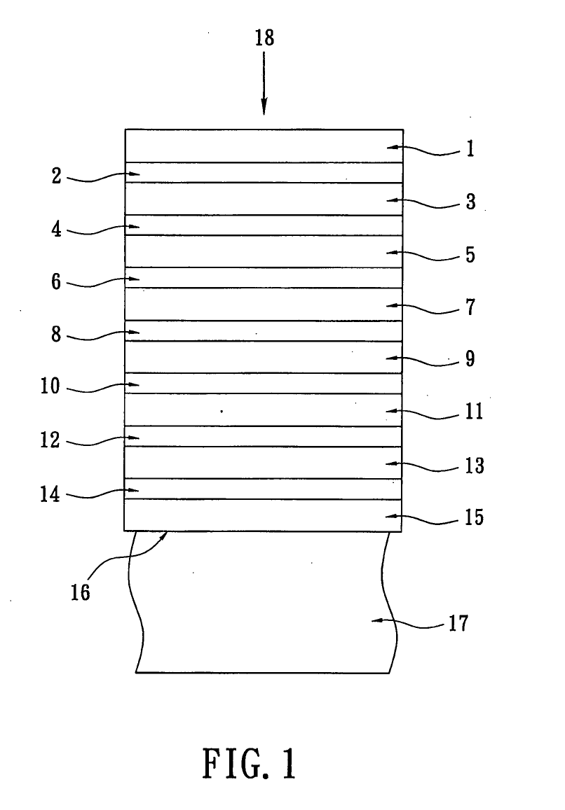

Reference is made to FIG. 1. A substrate 17 is composed of glass, a plastic film, or other transparent materials. A front surface 16 of the substrate 17 is that side of the substrate 17 that is facing the observer. An arrow 18 indicates the direction of viewing. A layer, which contacts the front surface 16 of the substrate 17, is named a fifteenth layer 15. In the direction the observer follows, the fourteenth layer 14 is arranged on the fifteenth layer 15, which is next to the front surface of the substrate 17. The thirteenth layer 13 is arranged on the fourth layer 14. The twelfth layer 12 is arranged on the thirteenth layer 13. The eleventh layer 11 is arranged on the twelfth layer 12. The tenth layer 10 is arranged on the eleventh layer 11. The ninth layer 9 is arranged on the tenth layer 10. The eighth layer 8 is arranged on the ninth layer 9. The seventh layer 7 is arranged on the eighth layer 8. The sixth layer 6 is arranged on the seventh layer 7. The fifth layer 5 is arranged on the sixth layer 6. The fourth layer 4 is arranged on the fifth layer 5. The third layer 3 is arranged on the fourth layer 4. The second layer 2 is arranged on the third layer 3. The first layer 1 is arranged on the second layer 2. The first layer 1 is called as a surface layer or outermost layer. The layers 1, 2, 3, 4, 5, 6, 7, 8, 9, 10, 11, 12, 14 and 15 form a layered system of the present invention.

The first (also known as the surface layer 1) is a ZnO:Al layer (capable of) slightly absorbing visible light, and scores between 1.9 and 2.2 on the refractive index at a wavelength of about 520 nanometers (nm) and has a physical thickness of 20 nm to 40 nm at the designed wavelength. The second layer 2 is a silver layer slightly absorbing visible light, and scores between 0.1 and 0.5 on the refractive index at a wavelength of about 520 nm and has a physical thickness of 8 to 12 nm at the designed wavelength. The third layer 3 is a ZnO:Al layer, and scores between 1.9 and 2.2 on the refractive index at a wavelength of about 520 nanometers (nm) and has a physical thickness between 30 nm to 80 nm at the designed wavelength. The fourth layer 4 is a silver layer, and scores between 0.1 and 0.5 on the refractive index at a wavelength of about 520 nm and has a physical thickness of 8 to 12 nm. The fifth layer 5 is a ZnO:Al layer, and scores between 1.9 and 2.2 on the refractive index at a wavelength of about 520 nanometers (nm) and has a physical thickness of 30 nm to 80 nm at the designed wavelength. The sixth layer 6 is a silver layer, and scores between 0.1 and 0.5 on the refractive index at a wavelength of about 520 nm and has a physical thickness of 8 to 12 nm. The seventh layer 7 is a ZnO:Al layer, and scores between 1.9 and 2.2 on the refractive index at a wavelength of about 520 nanometers (nm) and has a physical thickness of 30 nm to 80 nm at the designed wavelength. The eighth layer 8 is a silver layer, and scores between 0.1 and 0.5 on the refractive index at a wavelength of about 520 nm and has a physical thickness of 8 to 12 nm. The ninth layer 9 is a ZnO:Al layer, and scores between 1.9 and 2.2 on the refractive index at a wavelength of about 520 nanometers (nm) and has a physical thickness of 30 nm to 80 nm at the designed wavelength. The tenth layer 10 is a silver layer, and scores between 0.1 and 0.5 on the refractive index at a wavelength of about 520 nm and has a physical thickness of 8 to 12 nm. The eleventh layer 11 is a ZnO:Al layer, and scores between 1.9 and 2.2 on the refractive index at a wavelength of about 520 nanometers (nm) and has a physical thickness of 30 nm to 80 nm at the designed wavelength. The twelfth layer 12 is a silver layer, scores between 0.1 and 0.5 on the refractive index at a wavelength of about 520 nm, and has a physical thickness of 8 to 12 nm. The thirteenth layer 13 is a ZnO:Al layer, scores between 1.9 and 2.2 on the refractive index at a wavelength of about 520 nanometers (nm), and has a physical thickness of 30 nm to 80 nm at the designed wavelength. The fourteenth layer 14 is a thin metal material. The metal layer is made of silver slightly absorbing visible light, scores between 0.1 and 0.5 on the refractive index at a wavelength of about 520 nm, and has a physical thickness of 8 to 12 nm. The fifteenth or the innermost layer 15 is a TiO2 layer substantially non-absorbing visible light, scores between 2.2 and 2.4 on the refractive index at a wavelength of about 520 nm, and has a physical thickness of 20 to 40 nm at the designed wavelength.

In a preferred embodiment, the thickness of the first layer 1 is 35 nm. The thickness of the second layer 2 is 10 nm. The thickness of the third layer 3 is 75 nm. The thickness of the fourth layer 4 is 10 nm. The thickness of the fifth layer 5 is 55 nm. The thickness of the sixth layer 6 is 10 nm. The thickness of the seventh layer 7 is 55 nm. The thickness of the eighth layer 8 is 10 nm. The thickness of the ninth layer 9 is 55 nm. The thickness of the tenth layer 10 is 10 nm. The thickness of the eleventh layer 11 is 70 nm. The thickness of the twelfth layer 12 is 10 nm. The thickness of the thirteenth layer 13 is 70 nm. The thickness of the fourteenth layer 14 is 10 nm. The thickness of the fifteenth layer 15 is 33 nm.

A DC or AC magnetron sputtering is provided to deposit the first, third, fifth, seventh, ninth, eleventh and thirteenth layers 1, 3, 5, 7, 9, 11 and 13 from a ZnO:Al target in the presence of a sputter gas of Ar and a very small partial pressure of H₂O, under a given total pressure of approximately 3 m Torr (m=mili=0.001). For the second, fourth, sixth, eighth, tenth, twelfth and fourteenth layers 2, 4, 6, 8, 10, 12 and 14, it is proposed that a DC or AC magnetron sputtering from the silver target to generate a layer of silver in the presence of a sputter gas of Ar, under a given pressure of 4 m Torr, should be used. For the 15^{th} layer 15, it is proposed that an AC sputtering from the Ti target to generate a layer of TiO₂ in the presence of a sputter gas mixture comprising Ar and H₂O, under a given pressure of approximately 2 m Torr, should be used. The distance between the target and the substrate 17 is about 15 cm. A heating device is applied in the sputtering system. The substrate 17 temperature is maintained between 100 and 300° C. during the sputtering process.

The number of layers is not limited to 15. Any layer system that meets the design rule of HL(HL)NH is within the scope of the present invention.

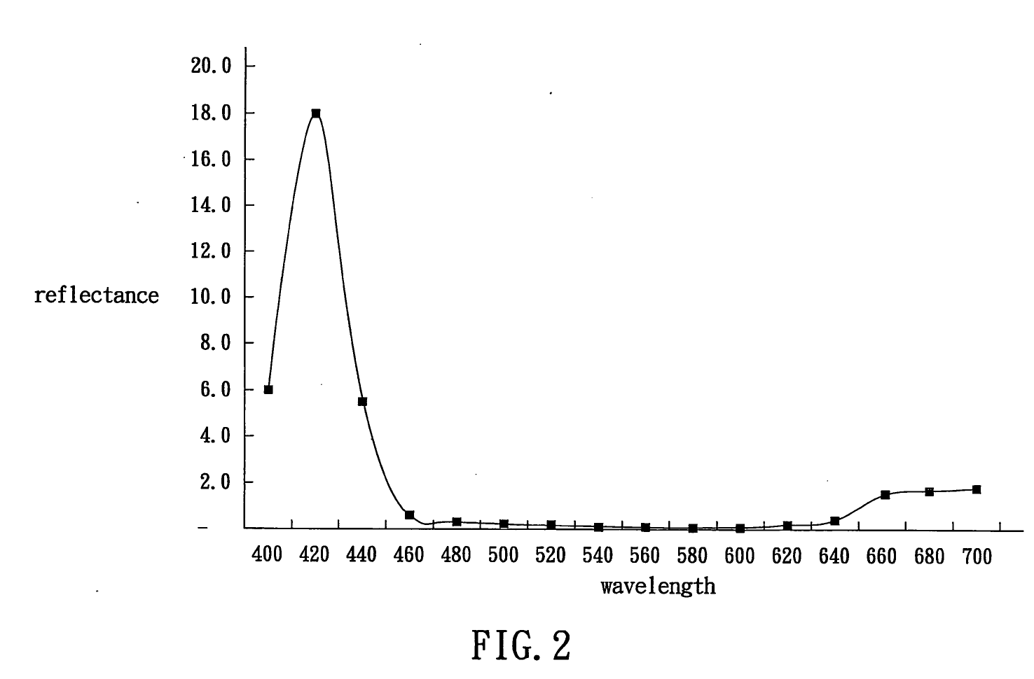

FIG. 2 shows the reflection spectrum for the layer system. The reflection was measured in percent at the front surface of the glass. The visible spectrum extends from a wavelength of 400 nm to a wavelength of 700 nm. The curve reveals clearly that the reflection in the core wavelength region of the visible light particularly between 460 and 600 nm is extraordinarily low. It lies below 0.5%. This result is better that the reflection spectrum measured from the layer system of the prior art with a design of HLHL.

The stated objects are achieved by the present invention. A conductive front surface with a resistance between 0.5Ω/square˜0.7Ω/square is obtained from the ITO coating, and a smooth wide band reflection spectrum is obtained on the glass or plastic film in the visible range from 400 nm to 700 nm. A highly conductive, light attenuation anti-reflection coating with a good surface conductivity is produced. Furthermore, a roll-to-roll vacuum deposition system is used to deposit the layer system of the present invention so that it can be manufactured at a low cost using high volume manufacturing methods.

The layer system of the present invention is also highly conductive for EMI (Electromagnetic Interference) shielding, low reflection for optical viewing, highly scratch resistance for surface hardness, and has moderate light attenuation effects for manufacturing PDP displays. For instance, the layer system has a surface resistance of between 0.5Ω/square and 0.7Ω/square and is hard enough to pass the scratch test of military standard MIL-C-48497.

The following advantages are achieved by the present invention. The problem of the transparent conductive layer (for example ITO), which was isolated by an insulating SiO2 film in a conventional anti-reflection layer system, is solved. The present invention provides a 15-layer system in which the surface material is ZnO:Al scoring between 1.9 and 2.2 on the refractive index.

Because the surface layer of the anti-reflection coating is electrical conductive, several simple processes can be applied to easily achieve a good electrical contact with the anti-reflection coating. For example, this layer system is used in a screen filter for plasma display.

On the application of a screen filter, the conventional grounding method of using an ultra-sonic welding process that produces small and bright contamination of tin spots will be replaced. The final process of assembling an anti-reflection coating on the screen filter will be simplified. The problem of forming non-uniform electric contact between the isolated conductive ITO layer and the tin solder will be solved. The yield of the grounding process will increase. The layered structure can also be used as a basic coating in the plasma display and liquid crystal display manufacturing industries.

Accordingly, the present invention of a 15-layer-system composed of electrically conductive materials to produce a surface layer is a simple easy, economic process for producing an anti-reflection coating on glass and plastic film substrates of low resistance.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A low resistivity light attenuation anti-reflection coating with a transparent surface conductive layer, comprising:
a substrate;
a fifteenth layer being arranged on a front surface of the substrate composed of an oxide scoring high on a refractive index, wherein the physical thickness of the fifteenth layer is between 20 nm and 40 nm;
a fourteenth layer being arranged on the fifteenth layer and composed of a metal scoring low on the refractive index, wherein the physical thickness of the fourteenth layer is between 8 nm and 12 nm;
a thirteenth layer being arranged on the fourteenth layer and composed of an oxide scoring high on the refractive index, wherein the physical thickness of the thirteenth layer is between 30 nm and 80 nm;
a twelfth layer being arranged on the thirteenth and composed of a metal scoring low on the refractive index, wherein the physical thickness of the twelfth layer is between 8 nm and 12 nm;
an eleventh layer being arranged on the twelfth layer and composed of an oxide scoring high on the refractive index, wherein the physical thickness of the eleventh layer is between 30 nm and 80 nm;
a tenth layer being arranged on the eleventh layer and composed of a metal scoring low on the refractive index, wherein the physical thickness of the tenth layer is between 8 nm and 12 nm;
a ninth layer being arranged on the tenth layer and composed of an oxide scoring high on the refractive index, wherein the physical thickness of the ninth layer is between 30 nm and 80 nm;
an eighth layer being arranged on the ninth layer and composed of a metal scoring low on the refractive index, wherein the physical thickness of the eighth layer is between 8 nm and 12 nm;
a seventh layer being arranged on the eighth layer and composed of an oxide scoring high on the refractive index, wherein the physical thickness of the seventh layer is between 30 nm and 80 nm;
a sixth layer being arranged on the seventh layer and composed of a metal scoring low on the refractive index, wherein the physical thickness of the sixth layer is between 8 nm and 12 nm;
a fifth layer being arranged on the sixth layer and composed of an oxide scoring high on the refractive index, wherein the physical thickness of the fifth layer is between 30 nm and 80 nm;
a fourth layer being arranged on the fifth layer and composed of a metal scoring low on the refractive index, wherein the physical thickness of the fourth layer is between 8 nm and 12 nm;
a third layer being arranged on the fourth layer and composed of an oxide scoring high on the refractive index, wherein the physical thickness of the third layer is between 30 nm and 80 nm;
a second layer being arranged on the third layer and composed of a metal scoring low on the refractive index, wherein the physical thickness of the second layer is between 8 nm and 12 nm; and
a first layer being arranged on the second layer and composed of an oxide scoring high on the refractive index, wherein the physical thickness of the first layer is between 20 nm and 40 nm.

2. The low resistivity light attenuation anti-reflection coating with a transparent surface conductive layer as claimed in claim 1, wherein the substrate is a plastic film.

3. The low resistivity light attenuation anti-reflection coating with a transparent surface conductive layer as claimed in claim 1, wherein the substrate is glass.

4. The low resistivity light attenuation anti-reflection coating with a transparent surface conductive layer as claimed in claim 1, wherein the first layer, the third layer, the fifth layer, the seventh layer, the ninth layer, the eleventh layer, and the thirteenth layer are composed of ZnO:Al, the second layer, the fourth layer, the sixth layer, the eighth layer, the tenth layer, the twelfth layer, and the fourteenth layer are composed of sliver, and the fifteenth layer is composed of TiO₂.

5. The low resistivity light attenuation anti-reflection coating with a transparent surface conductive layer as claimed in claim 1, wherein the first layer, the third layer, the fifth layer, the seventh layer, the ninth layer, the eleventh layer, and the thirteenth layer score between 1.9 and 2.2 on the refractive index, and the second layer, the fourth layer, the sixth layer, the eighth layer, the tenth layer, the twelfth layer, and the fourteenth layer score between 0.1 and 0.5 on the refractive index, and the fifteenth layer scores between 2.2 and 2.4 on the refractive index.

6. The low resistivity light attenuation anti-reflection coating with a transparent surface conductive layer as claimed in claim 1, wherein the oxide of the first layer, the third layer, the fifth layer, the seventh layer, the ninth layer, the eleventh layer, and the thirteenth layer is formed by a DC or AC magnetron sputtering method, the metal of the second layer, the fourth layer, the sixth layer, the eighth layer, the tenth layer, the twelfth layer, and the fourteenth layer is formed by a DC or AC magnetron sputtering method, and the oxide of the fifteenth layer is formed by an AC magnetron sputtering method.

7. The low resistivity light attenuation anti-reflection coating with a transparent surface conductive layer as claimed in claim 1, wherein all of the layers are formed by a in-line or roll-to-roll vacuum sputtering method.

8. The low resistivity light attenuation anti-reflection coating with a transparent surface conductive layer as claimed in claim 1, wherein the coating is a basic coating for a plasma display or a liquid crystal display.

9. A low resistivity light attenuation anti-reflection coating with a transparent surface conductive layer, comprising:
a substrate;
a fifth layer being arranged on the substrate and composed of an oxide scoring high on the refractive index;
a plurality of fourth layers composed of a metal scoring low on the refractive index;
a plurality of third layers composed of an oxide scoring high on the refractive index;
a second layer composed of a metal scoring low on the refractive index; and
a first layer composed of an oxide scoring high on the refractive index;
wherein the plurality of fourth layers and the plurality of third layers are staggered and stacked and are arranged on the fifth layer, the second layer is arranged on the last third layer, and the first layer is arranged on the second layer.

10. The low resistivity light attenuation anti-reflection coating with a transparent surface conductive layer as claimed in claim 9, wherein the physical thickness of the fifth layer is between 20 nm and 40 nm, the physical thickness of the fourth layer is between 8 nm and 12 nm, the physical thickness of the third layer is between 30 nm and 80 nm, the physical thickness of the second layer is between 8 nm and 12 nm, and the physical thickness of the first layer is between 20 nm and 40 nm.

11. The low resistivity light attenuation anti-reflection coating with a transparent surface conductive layer as claimed in claim 9, wherein the substrate is a plastic film.

12. The low resistivity light attenuation anti-reflection coating with a transparent surface conductive layer as claimed in claim 9, wherein the substrate is glass.

13. The low resistivity light attenuation anti-reflection coating with a transparent surface conductive layer as claimed in claim 9, wherein the first layer and the plurality of third layers are composed of ZnO:Al, the second layer and the plurality of fourth layers are composed of sliver, and the fifth layer is composed of TiO2.

14. The low resistivity light attenuation anti-reflection coating with a transparent surface conductive layer as claimed in claim 9, wherein the first layer and the plurality of third layers score between 1.9 and 2.2 on the refractive index, the second layer and the plurality of fourth layers score between 0.1 and 0.5 on the refractive index, and the fifth layer scores between 2.2 and 2.4 on the refractive index.

15. The low resistivity light attenuation anti-reflection coating with a transparent surface conductive layer as claimed in claim 9, wherein the oxide of the first layer and the plurality of third layers is formed by a DC or AC magnetron sputtering method, the metal of the second layer and the plurality of fourth layers is formed by a DC or AC magnetron sputtering method, and the oxide of the fifth layer is formed by an AC magnetron sputtering method.

16. The low resistivity light attenuation anti-reflection coating with a transparent surface conductive layer as claimed in claim 9, wherein all of the layers are formed by a in-line or roll-to-roll vacuum sputtering method.

17. The low resistivity light attenuation anti-reflection coating with a transparent surface conductive layer as claimed in claim 9, wherein the coating is a basic coating for a plasma display or a liquid crystal display.
